(19) United States
(12) Patent Application Publication
(10) Pub. No.: US 2018/0341476 A1
(43) Pub. Date: Nov. 29, 2018

(54) SOFTWARE UPDATING DEVICE, SOFTWARE UPDATING SYSTEM, AND SOFTWARE UPDATING METHOD

(71) Applicant: DENSO TEN Limited, Kobe-shi (JP)

(72) Inventor: Hideki KITAO, Kobe-shi (JP)

(73) Assignee: DENSO TEN Limited, Kobe-shi (JP)

(21) Appl. No.: 15/909,805

(22) Filed: Mar. 1, 2018

(30) Foreign Application Priority Data
May 25, 2017 (JP) 2017-103866

(51) Int. Cl. G06F 8/65; H04L 29/08

(52) U.S. Cl. CPC G06F 8/65; H04L 67/34

(57) ABSTRACT

There is provided a software updating device which performs communication with a server device and a plurality of control devices and controls software updating processes of control devices. A writing instruction unit instructs the control devices to write update software transmitted from the server device in second areas provided separately from first areas storing software which is being used. A confirming unit confirms that the update software has been written in the second areas with respect to all of control devices which constitute a cooperating control device group which is the set of control devices cooperating with each other, in the plurality of control devices which are software updating objects. A switching instruction unit instructs all of the control devices constituting the cooperating control device group to perform switching processes of setting the update software written in the second areas as software to be thereafter executed.

### CROSS-REFERENCE TO RELATED APPLICATIONS

This application is based on and claims priority under 35 USC 119 from Japanese Patent Application No. 2017-103866 filed on May 25, 2017.

### TECHNICAL FIELD

The present disclosure relates to a software updating device, a software updating system, and a software updating method.

### BACKGROUND

Patent Document 1 discloses a control system having a rewriting device for sequentially data items stored in memories of a plurality of microcomputers, one by one.

Also, Patent Document 2 discloses a software updating device for accessing a server and a plurality of control devices and performing transmission and reception of data. The software updating device downloads update information from the server and stores the update information in a storage unit. Thereafter, if the state of an engine transitions from an active state to an idle state, the software updating device performs updating processes on the individual control devices.

[Patent Document 1] Japanese Patent No. 5920243

[Patent Document 2] Japanese Patent Application Laid-Open No. 2016-170740

Recently, the number of electronic control units (ECUs) which are provided to one vehicle has significantly increased. For this reason, for example, in the case of applying the configuration of Patent Document 1 or 2 for updating software of ECUs, it is concerned that the time required for the software updating process will significantly lengthen. If the updating process lengthens in time, for example, it is concerned that the waiting time of the owner of a vehicle will excessively lengthen. Also, the software updating process needs to be performed when an engine is idle, and if the updating process takes a long time, the battery of the vehicle may run out.

It can be considered to stagger processes of updating software of the ECUs. For example, it can be considered to sequentially perform the software updating processes if the vehicle stops. In this case, it is possible to prevent the owner of the vehicle from waiting and prevent the battery of the vehicle from running out. However, in such a configuration, in ECUs cooperating with one another, ECUs on which software updating processes have been completed and ECUs on which software updating processes have not been completed may coexist with each other. If such coexistence occurs, the vehicle may malfunction, for example, due to a mismatch between interfaces or the like.

### SUMMARY

It is therefore an object of the present disclosure to provide a technology for efficiently and properly performing processes of updating software of control devices cooperating with one another.

According to an aspect of the embodiments of the present invention, a software updating device which performs communication with a server device and control devices and controls software updating processes of the control devices, the software updating device including: a writing instruction unit configured to instruct the control devices to write update software transmitted from the server device in second areas provided separately from first areas storing software which is being used; a confirming unit configured to confirm that the update software has been written in the second areas with respect to all of control devices which constitute a cooperating control device group which is the set of control devices cooperating with each other, in the control devices which are software updating objects; and a switching instruction unit configured to instruct all of the control devices constituting the cooperating control device group to perform switching processes of setting the update software written in the second areas as software to be thereafter executed.

In the software updating device, the switching instruction unit may instruct the control devices which do not belong to the cooperating control device group to perform switching processes, independently from the other control devices.

In the software updating device, in the case where cooperating control device groups exists, the switching instruction unit may separately instruct each of the cooperating control device groups to perform switching processes.

In the software updating device, in the case where the cooperating control device group includes a different type of control device incapable of performing writing of the update software according to an instruction from the writing instruction unit, with respect to control devices other than the different type of control device of all of the control devices constituting the cooperating control device group, the confirming unit may confirm that the update software has been written in the second areas, and the switching instruction unit may instruct the control devices other than the different type of control device of all of the control devices constituting the cooperating control device group to perform switching to the update software after confirmation of the confirming unit is completed and writing for updating software of the different type of control device is completed.

In the software updating device, the software updating device and the control devices may be mounted on a vehicle, and after confirmation of the confirming unit is completed, if a power supply of the vehicle is turned off first and then the power supply is turned on, the switching instruction unit may issue the instructions for the switching processes.

According to an aspect of the embodiments of the present invention, a software updating system including control devices, a software updating device configured to control processes of updating software of the control devices, and a server device configured to transmit update information of the software to the software updating device. A storage unit of each of the control devices includes: a first area where the software which is being used is stored; and a second area where update software included in the update information is stored, and the software updating device includes: a writing instruction unit configured to instruct the control devices to write the update software in the second areas; a confirming unit configured to confirm that the update software has been written in the second areas in all of control devices which are included in the control devices which are software updating objects and constitute a cooperating control device group which is the set of control devices cooperating with each other; and a switching instruction unit configured to instruct all of the control devices constituting the cooperating control device group to perform switching processes of setting the update software written in the second areas as software to be thereafter executed.

In the software updating system, by the switching processes, areas used as the second areas before switching may be switched to first areas, and areas used as the first areas may be switched to second areas.

According to an aspect of the embodiments of the present invention, a method of updating software of control devices by a software updating device performing communication with a server device and the control devices, including: instructing the control devices to write update software transmitted from the server device in second areas provided separately from first areas storing software which is being used; confirming that the update software has been written in the second areas with respect to all of control devices which constitute a cooperating control device group which is the set of control devices cooperating with each other, in the control devices which are software updating objects; and after the confirming is completed, a switching instruction of instructing all of the control devices constituting the cooperating control device group to perform switching processes of setting the update software written in the second areas as software to be thereafter executed.

According to an aspect of the embodiments of the present invention, it is possible to provide a technology for efficiently and properly performing processes of updating software of control devices cooperating with one another.

### BRIEF DESCRIPTION OF THE DRAWINGS

Exemplary embodiments of the present invention will be described in detail based on the following figures, wherein:

FIG. 1 is a view illustrating an outline of a software updating system;

FIG. 2 is a block diagram illustrating the configuration of a software updating device;

FIG. 3 is a block diagram illustrating the basic structure of an ECU;

FIG. 4 is a flow chart illustrating an outline of a software updating method which is performed by the software updating system;

FIG. 5 is a schematic diagram illustrating an image of switching to software to be executed;

FIG. 6 is a flow chart illustrating the first half part of the software updating method;

FIG. 7 is a flow chart illustrating the second half part of the software updating method;

FIG. 8 is a schematic diagram illustrating the relation between the software updating apparatus and individual ECUs constituting a cooperating ECU group during software updating processes;

FIG. 9 is a view for explaining a first modification of an embodiment of the present invention; and

FIG. 10 is a view for explaining a second modification of the embodiment of the present invention.

### DETAILED DESCRIPTION

Hereinafter, exemplary embodiments of the present invention will be described in detail with reference to the accompanying drawings.

<1. Outline of System>

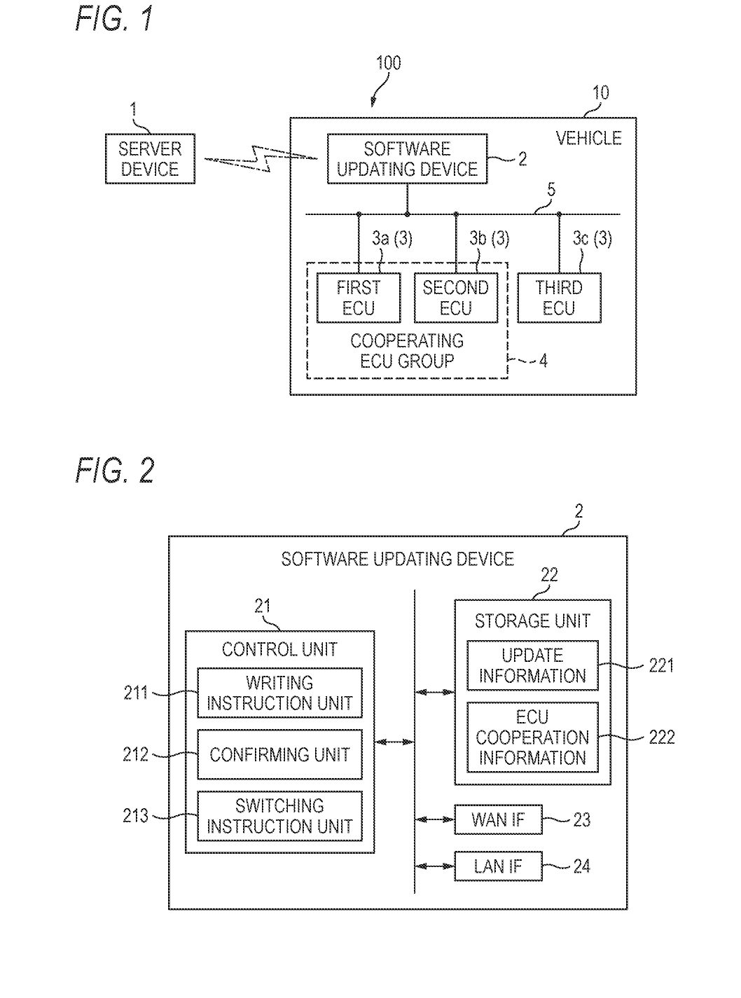

FIG. 1 is a view illustrating an outline of a software updating system 100 according to an embodiment of the present invention. The software updating system 100 is a system for performing processes of updating software of control devices of a vehicle 10. The software may be application software or may be system software. In the present embodiment, the software is control programs of the control devices. However, this is an example, and the software may include control information such as parameters and data required for control of the control devices.

As shown in FIG. 1, the software updating system 100 includes a server device 1, a software updating device 2, and ECUs 3. The ECUs 3 are examples of control devices of the present invention. The software updating device 2 and the ECUs 3 are mounted on the vehicle 10. In the present embodiment, the ECUs 3 includes a first ECU 3a, a second ECU 3b, and a third ECU 3c. The number of ECUs 3 is not particularly limited, and needs only to be two or more. The ECUs 3 fulfils different functions, respectively. The ECUs 3 may include, for example, an engine ECU for controlling the engine of the vehicle 10, a steering ECU for controlling the steering angle of the steering of the vehicle 10, a brake ECU for controlling the brake of the vehicle 10, a shift ECU for controlling the shift of the vehicle 10, an ECU for controlling the power supply of the vehicle 10, a light ECU for controlling the lights of the vehicle 10, and the like.

In the present embodiment, the first ECU 3a and the second ECU 3b cooperate with each other, and constitute a cooperating ECU group 4. The cooperating ECU group 4 is an example of a cooperating control device group of the present invention. The cooperating ECU group 4 is a set of ECUs 3 configured to perform control in cooperation with each other. For example, the first ECU 3a and the second ECU 3b may be included in ECUs constituting an advanced driver assistance system (ADAS). More specifically, the first ECU 3a and the second ECU 3b may be included in ECUs constituting, for example, an automatic brake system. For example, the first ECU 3a is a brake ECU, and the second ECU 3b may be a steering ECU.

The server device 1 and the software updating device 2 perform exchange of information by performing communication via a network such as the Internet. The server device 1 transmits software update information to the software updating device 2. The software updating device 2 and the ECUs 3 perform exchange of information by performing communication via an in-vehicle LAN (Local Area Network) 5. The software updating device 2 controls processes of updating the software of the ECUs 3.

According to the software updating system 100, it is possible to receive software update information from the server device 1 and update the software of each of the ECUs 3. Therefore, it is possible to quickly obtain software update information and perform software updating processes at early timings.

<2. Configuration of Software Updating Device>

FIG. 2 is a block diagram illustrating the configuration of the software updating device 2 according to the embodiment of the present invention. The software updating device 2 controls the processes of updating the software of the ECUs 3 by performing communication with the server device 1 and the ECUs 3. As shown in FIG. 2, the software updating device 2 includes a control unit 21, a storage unit 22, a WAN (Wide Area Network) interface (hereinafter, referred to as WAN-IF) 23, and a LAN (Local Area Network) interface (hereinafter, referred to as LAN-IF) 24.

The control unit 21 is a computer having a central processing unit (CPU) (not shown in the drawings). The control unit 21 controls the whole of the software updating device 2 by performing processing, transmission, and reception of information on the basis of a control program stored in, for example, the storage unit 22. The control unit 21 includes a writing instruction unit 211, a confirming unit 212, and a switching instruction unit 213. The CPU performs computing according to a program stored in the storage unit 22, whereby the functions of the individual units 211 to 213 are implemented. Details of the individual functional units 211 to 213 will be described below.

The storage unit 22 includes a volatile memory and a non-volatile memory. The volatile memory is for temporarily storing a variety of information such as data necessary for the operation of the control program. The non-volatile memory is for storing control information for operating the software updating device 2, such as the control program and parameters. The non-volatile memory may be, for example, an EEPROM, a flash memory, a hard disk drive, or the like. A part or the whole of the non-volatile memory may be configured with a portable storage medium such as an SD memory card (registered as a trade mark) or a USB (Universal Serial Bus) memory, such that it can be installed in and removed from the main body of the software updating device 2.

In the present embodiment, in the storage unit 22, software update information 221 transmitted from the server device 1 is stored. Also, in the storage unit 22, ECU cooperation information 222 representing which of the ECUs 3 are ECUs 3 cooperating with each other is stored. In the present embodiment, the control unit 21 can recognize that the first ECU 3a and the second ECU 3b are ECUs cooperating with each other, on the basis of the ECU cooperation information 222. Further, in the storage unit 22, a variety of information necessary to update the ECUs 3 by the software updating device 2, such as information on the configurations of ECUs 3 connected to the software updating device 2 and the software update states of the individual ECUs 3.

The WAN-IF 23 enables the software updating device 2 to perform data communication with the server device 1 via the network such as the Internet. In the present embodiment, the WAN-IF 23 is configured as a wireless communication unit. The WAN-IF 23 may be configured as a wire communication unit.

The LAN-IF 24 enables the software updating device 2 to perform data communication with the ECUs 3 via the in-vehicle LAN 5. In the present embodiment, the software updating device 2 and the ECUs 3 are connected by wire. In some cases, they may be connected wirelessly.

<3. Configurations of ECUs>

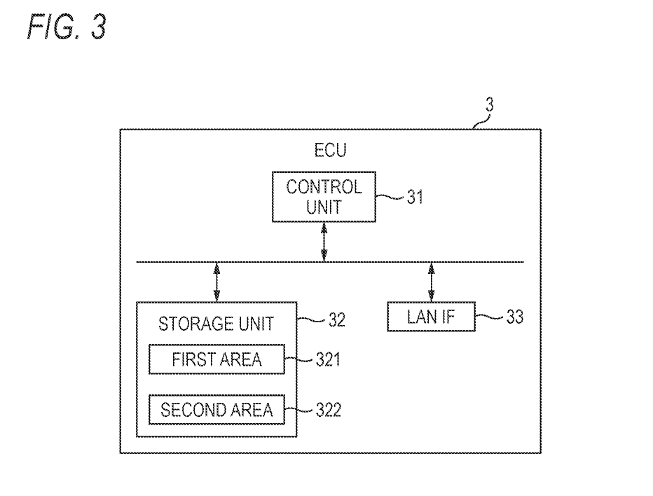

In the present embodiment, the software updating system 100 includes the first ECU 3a, the second ECU 3b, and the third ECU 3c. These ECUs 3a to 3c have the same basic structure. With reference to FIG. 3, the basic structure of an ECU 3 will be described. FIG. 3 is a block diagram illustrating the basic structure of an ECU 3 according to the embodiment of the present invention. As shown in FIG. 3, an ECU 3 includes a control unit 31, a storage unit 32, and a LAN-IF 33.

The control unit 31 is a computer having a CPU (not shown in the drawings). The control unit 31 controls the whole of the ECU 3 by performing processing, transmission, and reception of information on the basis of a program stored in, for example, the storage unit 32. Specifically, the control unit 31 operates according to a control program for performing a normal operation, and sometimes operates according to reprogramming software. In this specification, an operation mode according to the reprogramming software is referred to as a reprogramming mode. The reprogramming mode is applied for performing software updating processes.

Similarly to the software updating device 2, the storage unit 32 includes a volatile memory and a non-volatile memory. In the present embodiment, the storage unit 32 of each of the ECUs 3 has a first area 321 and a second area 322. The first area 321 is a software storage area where a control program (software) which is being used is stored. The second area 322 is a software storage area where update software included in the update information which the software updating device 2 received from the server device 1 is stored.

The LAN-IF 33 enables the ECU 3 to perform data communication with the software updating device 2 via the in-vehicle LAN 5.

<4. Functions of Software Updating Device>

Details of the individual functional units 211 to 213 (see FIG. 2) included in the control unit 21 of the software updating device 2 will be described.

The writing instruction unit 211 instructs each ECU 3 to write the update software transmitted from the server device 1 in the second area 322 provided separately from the first area 321. Specifically, the writing instruction unit 211 determines which of the ECUs the update software transmitted from the server device 1 is update software for, and issues write instructions to ECUs 3 which are updating objects. Information on which update software is update software for which ECUs 3 is included in, for example, the update information or the update software transmitted from the server device 1.

Also, the update software needs only to be written in the second area 322 provided separately from the first area 321. Therefore, when software stored in the first area 321 is being executed, it is possible to perform an update software writing process in the background.

The confirming unit 212 confirms that the update software has been written in the second areas 322, with respect to all of ECUs 3 which are included in the ECUs 3 which is software updating objects and constitute the cooperating ECU group 4. Also, the cooperating ECU group 4 is the set of ECUs 3 configured to perform control in cooperation with each other. In the present embodiment, the cooperating ECU group 4 is composed of the first ECU 3a and the second ECU 3b. Specifically, the confirming unit 212 recognizes the ECUs 3 constituting the cooperating ECU group 4, on the basis of the ECU cooperation information 222 stored in the storage unit 22. In the case where there is no cooperating ECU group 4 in the ECUs 3 which is the software updating objects, confirmation of the confirming unit 212 is not actually performed.

The switching instruction unit 213 instructs all of the ECU 3 constituting the cooperating ECU group 4 to switch software to be thereafter executed to the update software written in the second areas 322. Specifically, the switching instruction unit 213 instructs all of the ECUs 3 constituting the cooperating ECU group 4 to switch the software, in the same period. The switching instructions of the switching instruction unit 213 are issued after confirmation of the confirming unit 212 is completed. In other words, the switching instruction unit 213 does not issue the switching instructions until it is confirmed that the update software has been written in the second areas 322 in all of the ECUs 3 constituting the cooperating ECU group 4.

According to the present embodiment, each ECU 3 can write the update software in the background while performing a normal operation. In other words, according to the present embodiment, it is possible to shorten the time required to perform the processes of updating old versions of software with new versions after stopping the engine of the vehicle 10.

Also, according to the present embodiment, it is possible to update the software of the ECUs 3 constituting the cooperating ECU group 4 in the same period. Therefore, it is possible to prevent an ECU on which the software updating process has been completed and an ECU on which the software updating process has not been completed from coexisting in the ECUs 3 cooperating with each other. In other words, according to the present embodiment, it is possible to prevent a mismatch between the ECUs cooperating with each other from occurring, resulting in malfunction and so on.

<5. Software Updating Method>

<5-1. Outline of Software Updating Method>

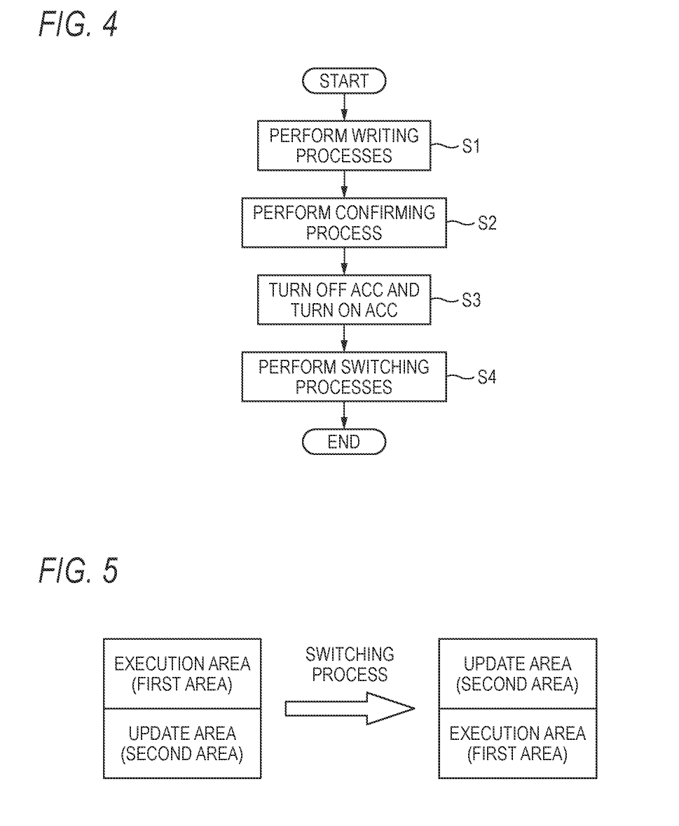

FIG. 4 is a flow chart illustrating an outline of the software updating method which is performed by the software updating system 100 according to the embodiment of the present invention. If the software updating device 2 receives the update information from the server device 1 as a previous step, the received update information is stored in the storage unit 22. The software updating device 2 confirms the validity of the received update information.

Thereafter, the writing instruction unit 211 instructs the ECUs 3 which are software updating objects to write the update software in the second areas 322 (STEP 51). According to the write instructions from the software updating device 2, the control units 31 of the ECUs 3 which are the software updating objects perform writing processes. It is preferable to perform the writing processes in the backgrounds while executing the software stored in the first areas 321. In this case, it is possible to shorten the time required to perform the software updating processes in the state where the engine of the vehicle 10 is idle.

Also, the second areas 322 may store old versions of software before writing of the update software is performed. In this case, the control units 31 of the ECUs 3 first delete the old versions of software and then perform writing of the update software. In other words, in the software writing processes of the embodiments, software rewriting processes are included.

Next, the confirming unit 212 performs a step of confirming that the update software has been written in the second areas 322 in all of the ECUs 3 constituting the cooperating ECU group 4 (STEP S2). However, ECUs 3 which do not belong to any cooperating ECU group 4 may be included in ECUs 3 which are software updating objects. Such ECUs 3 which do not belong to any cooperating ECU group 4 is excluded from objects of the confirming process of the confirming unit 212.

After confirmation of the confirming unit 212 is completed, in other words, after the confirming unit 212 confirms that the update software has been written in the second areas 322 in all of the ECUs 3 constituting the cooperating ECU group 4, the power supply of the vehicle 10 is turned off first, and then the power supply is turned on (STEPS S3). In the present embodiment, turning on and off of the power supply is turning on and off of an ACC.

After the ACC is turned on, the switching instruction unit 213 instructs all of the ECUs 3 constituting the cooperating ECU group 4 to perform switching processes of switching software to be thereafter executed to the update software written in the second areas 322, in the same period (STEP S4). According to the switching instructions, the individual ECUs 3 changes software to be thereafter executed to the update software written in the second areas 322.

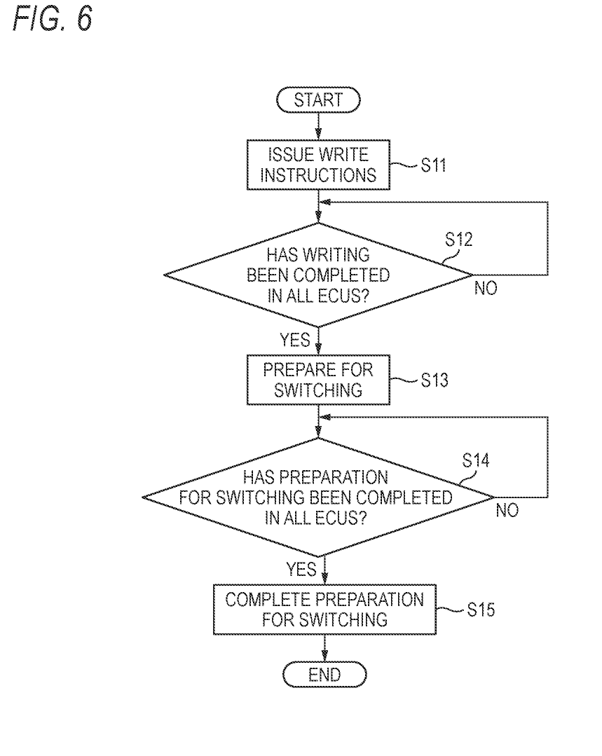

FIG. 5 is a schematic diagram illustrating an image of switching of software to be executed. As shown in FIG. 5, in the present embodiment, by the switching processes, areas which have been used as the second areas until switching are switched to first areas, and areas which have been used as the first areas are switched to second areas. Therefore, it is unnecessary to set storage areas larger than necessary for software updating processes, and it is possible to minimize the storage capacities of the storage units 32.

In the present embodiment, after confirmation of the confirming unit 212 is completed, the power supply of the vehicle 10 is turned on first, and then the power supply is turned off. Thereafter, the switching instruction unit 213 issues the instruction for the switching processes. In the present embodiment, turning on and off of the power supply is turning on and off of the ACC. Therefore, it is possible to perform downloading of the update software to the individual ECUs 3 while the engine of the vehicle 10 is operating. Thereafter, it is possible to intensively perform switching to the update software in the ECUs 3 before the stopped engine restarts. Therefore, it is possible to safely and efficiently perform the software updating processes.

Also, in ECUs 3 which are the software updating objects, ECUs 3 belonging to cooperating ECU groups 4 and ECU 3 which do not belong to any cooperating ECU group 4 may be included. Such ECUs 3 which do not belong to any cooperating ECU group 4 do not need to perform updating of software in cooperation with other ECUs 3. Also, in the case where at least one ECU 3 which each is a software updating object does not include any cooperating ECU group 4, each ECU 3 is an ECU which does not belong to any cooperating ECU group 4, and does not need to perform updating of software in cooperation with other ECUs 3. In other words, with respect to such ECUs 3, the confirming process which is performed in STEP S2 is unnecessary. In the present embodiment, the switching instruction unit 213 instructs each ECU 3 which does not belong to the cooperating ECU group 4 to perform a switching process independently from the other ECUs 3. Therefore, each ECU 3 which does not belong to any cooperating ECU group 4 can perform a software updating process at an appropriate timing. For example, the software updating process of each ECU 3 which does not belong to any cooperating ECU group 4 may be performed independently or may be performed depending on the update dates and times of the other ECUs 3.

Also, at an appropriate timing before the switching processes are performed, whether a user wants updating may be checked, and only when the user wants updating, the software updating processes may be performed. To ask the user for confirmation, for example, screen display or sound may be used. To issue an instruction, the user may use, for example, an input key, voice input, and so on.

<5-2. Details of Software Updating Method>

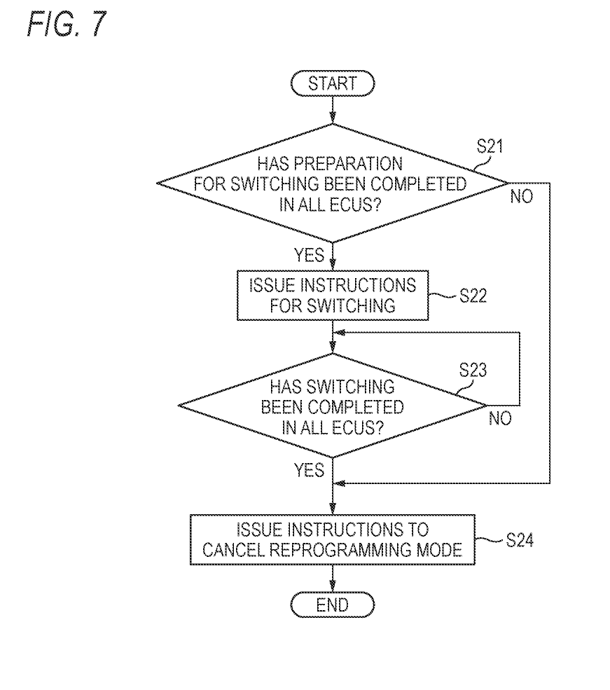

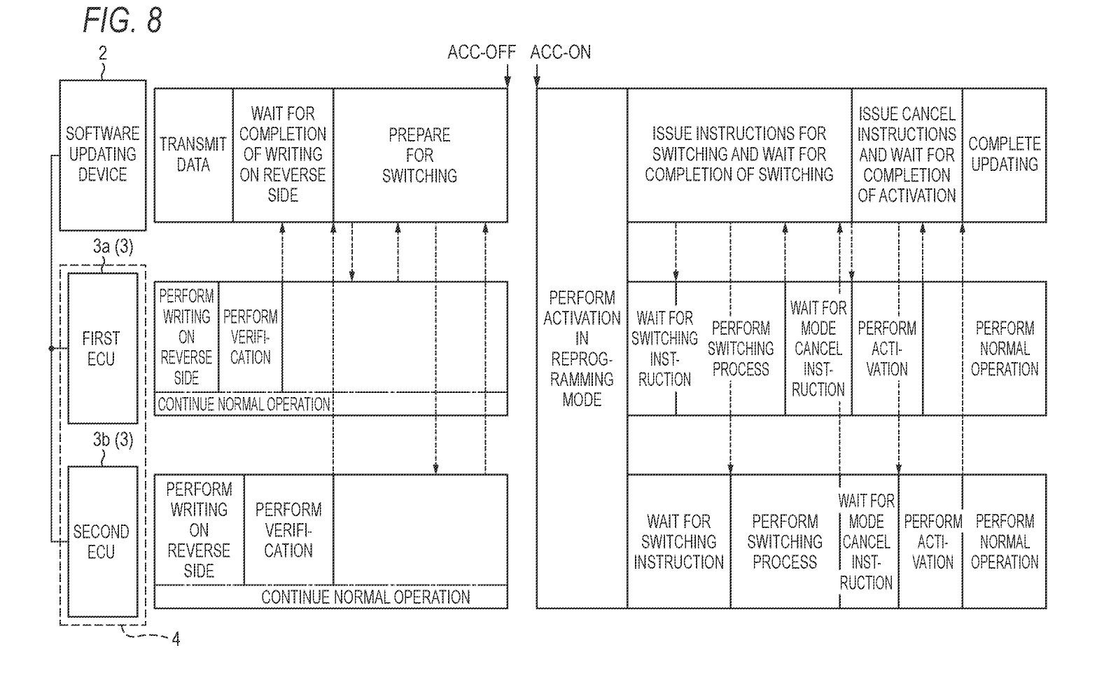

Now, a software updating method of each ECU 3 constituting the cooperating ECU group 4 in the case where the cooperating ECU group 4 is included in the ECUs 3 which is the software updating objects will be described in more detail. FIG. 6 is a flow chart illustrating the first half part of the software updating method. FIG. 7 is a flow chart illustrating the second half part of the software updating method. FIG. 8 is a schematic diagram illustrating the relation between the software updating device 2 and the individual ECUs 3 constituting the cooperating ECU group 4 during the software updating processes. Also, in the present embodiment, the cooperating ECU group 4 is composed of the first ECU 3a and the second ECU 3b. Further, in the present embodiment, as a preferred example, the flow shown in FIG. 6 is performed when the engine of the vehicle 10 is operating. As a preferred example, the flow shown in FIG. 7 is performed when the engine of the vehicle 10 is idle.

As shown in FIG. 6, the software updating device 2 issues update software write instructions to the first ECU 3a and the second ECU 3b constituting the cooperating ECU group 4 (STEP S11). Specifically, as shown in FIG. 8, the software updating device 2 transmits data on corresponding update software to the ECUs 3a and 3b, respectively. Each of the ECUs 3a and 3b writes the update software transmitted from the software updating device 2 in the second area 322 in the background. After writing of the update software, each of the ECUs 3a and 3b performs verification. Also, while performing writing and verification in the background, each of the ECUs 3a and 3b operates according to the control program stored in the first area 321. In other words, each of the ECUs 3a and 3b performs the update software writing process while continuing the normal operation.

As shown in FIG. 6, if the update software writing processes start in the individual ECUs 3a and 3b, the software updating device 2 monitors whether the update software writing processes have been completed in all of the ECUs 3a and 3b constituting the cooperating ECU group 4 (STEP S12). Specifically, as shown in FIG. 8, after the data transmission, the software updating device 2 waits for write completion notifications from the individual ECUs 3a and 3b. After completion of verification, each of the ECUs 3a and 3b transmits a write completion notification to the software updating device 2.

As shown in FIG. 6, if the software updating device 2 recognizes that the update software writing processes have been completed in all of the ECUs 3a and 3b constituting the cooperating ECU group 4, it instructs the individual ECUs 3a and 3b to prepare for switching (STEP S13). As shown in FIG. 8, by these instructions, each of the ECUs 3a and 3b recognizes that writing has been completed even in the other ECU, and notifies the software updating device 2 that it has entered a switching wait state.

As shown in FIG. 6, the software updating device 2 monitors whether all of the ECUs 3a and 3b constituting the cooperating ECU group 4 have entered the switching wait state (STEP S14). If all of the ECUs 3a and 3b notify that they have entered the switching wait state, the software updating device 2 recognizes completion of preparation for switching. Specifically, the software updating device 2 recognizes that it is possible to perform the second half part of the software updating process. The second half part is a process of switching software to be executed. In the present embodiment, in view of safety and so on, the software switching processes are performed when the engine is idle. Therefore, as shown in FIG. 8, after recognizing that all of the ECUs 3a and 3b constituting the cooperating ECU group 4 have entered the switching wait state, the software updating device 2 puts the switching processes on hold, and waits for the ACC of the vehicle 10 to be turned off first.

As shown in FIG. 8, if the ACC of the vehicle 10 is turned off first and then the ACC is turned on, the software updating device 2 performs the switching process. If the ACC is turned on, each of the ECUs 3a and 3b is activated in the reprogramming mode.

As shown in FIG. 7, if the ACC of the vehicle 10 is turned on, the software updating device 2 re-determines whether preparation for switching has been completed in all of the ECUs 3a and 3b constituting the cooperating ECU group 4 (STEP S21). During this period, each of the ECUs 3a and 3b waits for an instruction from the software updating device 2.

In the case where at least ECU of the ECUs 3a and 3b constituting the cooperating ECU group 4 is not ready for switching (“No” in STEPS S21), since it is impossible to perform the switching processes, the software updating device 2 instructs each of the ECUs 3a and 3b to cancel the reprogramming mode. Each of the ECUs 3a and 3b cancels the reprogramming mode, and stops the software updating process, and activates the software stored in the first area 321, and performs the normal operation.

As shown in FIG. 7, after confirming that preparation for switching has been completed (“Yes” in STEP S21), the software updating device 2 instructs each of the ECUs 3a and 3b constituting the cooperating ECU group 4 to perform the switching process. According to this instruction, as shown in FIG. 8, each of the ECUs 3a and 3b performs the switching process of switching software to be thereafter executed to the update software written in the second area 322. After completion of the switching process, each of the ECUs 3a and 3b notifies the completion to the software updating device 2.

As shown in FIG. 7, after issuing the instructions for switching, the software updating device 2 monitors whether all of the ECUs 3a and 3b constituting the cooperating ECU group 4 have completed the switching processes (STEP S23). If receiving completion notifications from all of the ECUs 3a and 3b constituting the cooperating ECU group 4, the software updating device 2 recognizes the completion of the switching processes. As shown in FIG. 8, after notifying the completion, each of the ECUs 3a and 3b waits for an instruction to cancel the reprogramming mode.

As shown in FIG. 7, if the software updating device 2 recognizes the switching processes of all of the ECUs 3a and 3b constituting the cooperating ECU group 4 (“Yes” in STEP S23), it instructs each of the ECUs 3a and 3b to cancel the reprogramming mode (STEPS S24). According to these instructions, as shown in FIG. 8, each of the ECUs 3a and 3b activates the update software, and starts the normal operation. Each of the ECUs 3a and 3b notifies completion of activation of the update software to the software updating device 2. Due to these notifications, the software updating device 2 recognizes that the normal operations according to the update software have started in all of the ECUs 3a and 3b constituting the cooperating ECU group 4, and recognizes the completion of the updating.

In the present embodiment, the process of switching between old and new software of the ECUs 3 constituting the cooperating ECU group 4 is performed in two phases of preparation for switching and performance of switching. Therefore, after the software updating device recognizes that all of the ECUs 3 constituting the cooperating ECU group 4 are ready to perform switching to the new software, it can instruct the individual ECUs 3 constituting the cooperating ECU group 4 to perform switching of the software, in the same period. As a result, it is possible to perform updating of the software, without causing a mismatch between the ECUs 3 cooperating with each other.

Until entering the reprogramming mode, it is possible to use the software which is being used, without any change, to perform the update software writing processes while the vehicle 10 is running. Also, since it is possible to set only processes related to switching, as processes which are performed for the software updating processes while the engine is idle, it is possible to perform the software updating processes while minimizing the probability that the battery will run out. Also, it is possible to shorten the waiting time of the user for the software updating processes.

Also, in STEP S23, the software updating device 2 may not be able to recognize the completion notifications of all of the ECUs 3a and 3b constituting the cooperating ECU group 4 even after a predetermined time. In this case, it is difficult to start activation of the engine, which makes the user wait. In order to avoid this situation, in the case where the software updating device 2 cannot receive completion notifications of all of the ECUs 3a and 3b in a predetermined time, the software updating processes may be stopped. In the case of determining to stop updating, the software updating device 2 instructs all of the ECUs 3a and 3b constituting the cooperating ECU group 4 to perform activation according to the software before updating. Also, the software before updating is the software stored in the first areas 321.

<6. Modifications and Others>

<6-1. First Modification>

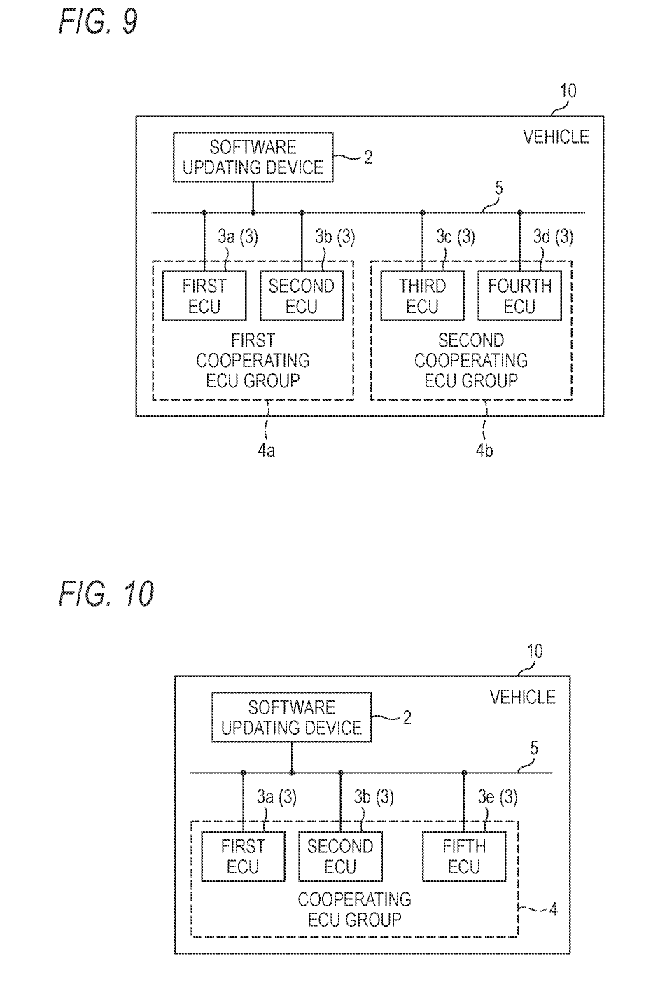

FIG. 9 is a view for explaining a first modification of the embodiment of the present invention. As shown in FIG. 9, in the first modification, the first ECU 3a and the second ECU 3b cooperate with each other, and constitute a first cooperating ECU group 4a. The third ECU 3c and a fourth ECU 3d cooperate with each other, and constitute a second cooperating ECU group 4b. In other words, in the first modification, cooperating ECU groups exists. Also, the basic structure of the fourth ECU 3d is the same as those of the other ECUs 3a to 3c.

In the case where cooperating ECU groups 4 exists, the switching instruction unit 213 of the software updating device 2 separately instructs each of the cooperating ECU groups to perform switching processes. In the present modification, the first cooperating ECU group 4a and the second cooperating ECU group 4b performs switching processes independently. According to this configuration, it is possible to avoid performing the updating processes of many types of cooperating ECU groups intensively in a certain period, and thus it is possible to avoid making the user wait for a long time and running out of the battery.

Also, in some cases, the same date and time may be set for the updating processes of the cooperating ECU groups, and the updating processes of the cooperating ECU groups may be performed in a certain period.

<6-2. Second Modification>

FIG. 10 is a view for explaining a second modification of the embodiment of the present invention. As shown in FIG. 10, in the second modification, on the vehicle 10, the first ECU 3a, the second ECU 3b, and a fifth ECU 3e are provided. The basic structures of the first and second ECUs 3a and 3b are as described above. The fifth ECU 3e is from the first and second ECUs 3a and 3b in the structure and the update software writing system. Also, the first ECU 3a, the second ECU 3b, and the fifth ECU 3e cooperate with one another and constitute a cooperating ECU group 4.

In the present modification, the cooperating ECU group 4 includes a different type of ECU (the fifth ECU 3e) incapable of performing writing of update software according to an instruction from the writing instruction unit 211. Accordingly, the functions of the confirming unit 212 and the switching instruction unit 213 are slightly different from those of the configuration of the embodiment described above. In other words, the confirming unit 212 confirms that update software has been written in the second areas 322 with respect to the ECUs 3a and 3b of all of the ECUs 3a, 3b, and 3e constituting the cooperating ECU group 4 except for the different type of ECU 3e described above. After confirmation of the confirming unit 212 is completed and rewriting for updating software of the different type of ECU 3e is completed, the switching instruction unit 213 instructs the ECUs 3a and 3b of all of the ECUs 3a, 3b, and 3e constituting the cooperating ECU group 4 except for the different type of ECU 3e to perform switching to update software. In the present modification, the switching instruction unit 213 instructs the ECUs 3a and 3b of all of the ECUs 3a, 3b, and 3e constituting the cooperating ECU group 4 except for the different type of ECU 3e to perform switching to the update software, in the same period.

Details will be described with examples. First, when the engine is operating, according to the instructions of the software updating device 2, the update software is written in the second areas 322 of the first ECU 3a and the second ECU 3b, and preparation for switching (see FIG. 8 for instance) is completed. If the ACC is turned off first, and then the ACC is turned on, each of the ECUs 3a, 3b, and 3e constituting the cooperating ECU group 4 is activated in the reprogramming mode.

After activation according to the reprogramming mode, first, old versions of software of the fifth ECU 3e is rewritten with new versions by using the software updating device 2. For example, the rewriting process may be performed by a system based on the SAE (Society of Automotive Engineers, Inc.) standards, UDS (Unified Diagnosis Services) standards, or the like. After this rewriting process is completed, switching processes of the first and second ECUs 3a and 3b are performed in the same period. Thereafter, in all of the ECUs 3a, 3b, and 3e, the reprogramming mode is canceled, and activation of the update software is performed. As a result, in all of the ECUs 3a, 3b, and 3e constituting the cooperating ECU group 4, the software updating processes are completed in the same period. In other words, it is possible to prevent a mismatch between ECUs cooperating with each other from occurring.

<6-3. Others>

The configurations of the embodiment and the modifications shown in this specification are just examples of the present invention. The configurations of the embodiment and the modifications may be appropriately modified without departing from the technical idea of the present invention. Also, some of the embodiment and modifications may be appropriately combined within an acceptable range.

Also, in the embodiment described above, various functions of the software updating device is implemented in software wise by computing of the CPU according to the program; however, at least a part of those functions may be implemented by electrical hardware circuits.

Also, the case where the present invention is applied to software updating processes of the ECUs mounted on the vehicle has been described above; however, this is an example. The embodiments of the present invention can be widely applied to software updating processes of devices each of which has ECUs cooperating with each other, like home electric appliances, transport aircrafts other than vehicles, and so on.

What is claimed is:

1. A software updating device which performs communication with a server device and a plurality of control devices and controls software updating processes of the plurality of control devices, the software updating device comprising:
a writing instruction unit configured to instruct the control devices to write update software transmitted from the server device in second areas provided separately from first areas storing software which is being used;
a confirming unit configured to confirm that the update software has been written in the second areas with respect to all of control devices which constitute a cooperating control device group which is the set of control devices cooperating with each other, in the plurality of control devices which are software updating objects; and
a switching instruction unit configured to instruct all of the control devices constituting the cooperating control device group to perform switching processes of setting the update software written in the second areas as software to be thereafter executed.

2. The software updating device according to claim 1, wherein:
the switching instruction unit instructs the control devices which do not belong to the cooperating control device group to perform switching processes, independently from the other control devices.

3. The software updating device according to claim 1, wherein:
in the case where a plurality of cooperating control device groups exists, the switching instruction unit separately instructs each of the cooperating control device groups to perform switching processes.

4. The software updating device according to claim 1, wherein:
in the case where the cooperating control device group includes a different type of control device incapable of performing writing of the update software according to an instruction from the writing instruction unit,
with respect to control devices other than the different type of control device of all of the control devices constituting the cooperating control device group, the confirming unit confirms that the update software has been written in the second areas, and
the switching instruction unit instructs the control devices other than the different type of control device of all of the control devices constituting the cooperating control device group to perform switching to the update software after confirmation of the confirming unit is completed and writing for updating software of the different type of control device is completed.

5. The software updating device according to claim 1, wherein:
the software updating device and the plurality of control devices are mounted on a vehicle, and
after confirmation of the confirming unit is completed, if a power supply of the vehicle is turned off first and then the power supply is turned on, the switching instruction unit issues the instructions for the switching processes.

6. A software updating system comprising a plurality of control devices, a software updating device configured to control processes of updating software of the plurality of control devices, and a server device configured to transmit update information of the software to the software updating device, wherein:
a storage unit of each of the plurality of control devices comprises:
a first area where the software which is being used is stored; and
a second area where update software included in the update information is stored, and
the software updating device comprises:
a writing instruction unit configured to instruct the control devices to write the update software in the second areas;
a confirming unit configured to confirm that the update software has been written in the second areas in all of control devices which are included in the plurality of control devices which are software updating objects and constitute a cooperating control device group which is the set of control devices cooperating with each other; and
a switching instruction unit configured to instruct all of the control devices constituting the cooperating control device group to perform switching processes of setting the update software written in the second areas as software to be thereafter executed.

7. The software updating system according to claim 6, wherein:
by the switching processes, areas used as the second areas before switching are switched to first areas, and areas used as the first areas are switched to second areas.

8. A method of updating software of a plurality of control devices by a software updating device performing communication with a server device and the control devices, comprising:
instructing the control devices to write update software transmitted from the server device in second areas provided separately from first areas storing software which is being used;
confirming that the update software has been written in the second areas with respect to all of control devices which constitute a cooperating control device group which is the set of control devices cooperating with each other, in the plurality of control devices which are software updating objects; and
after the confirming is completed, a switching instruction of instructing all of the control devices constituting the cooperating control device group to perform switching processes of setting the update software written in the second areas as software to be thereafter executed.
